(19) United States
(12) Patent Application Publication
(10) Pub. No.: US 2007/0233925 A1
(43) Pub. Date: Oct. 4, 2007

(54) Centralized management of data nodes

(75) Inventors: Yuebo Zhou, Anshan (CN); Robin Huang, Shanghai (CN); Kevin Li, Shanghai (CN)

Correspondence Address: KENYON & KENYON LLP, 1500 K STREET N.W., WASHINGTON, DC, 20005, US

(73) Assignee: SAP AG, Walldorf (DE)

(21) Appl. No.: 11/395,408

(22) Filed: Mar. 31, 2006

(51) Int. Cl. G06F 13/24

(52) U.S. Cl. 710/266

(57) ABSTRACT

A centralized dependency management table for saving the dependency information about all nodes in a netlike data management system. When a user activates, modifies or deletes one node, the system will search the centralized dependency table for the dependency information about the target node and its related nodes. The system will determine whether it is necessary to check the dependency relationship or fields of a node according to the dependency relationships, and will determine whether a maintenance operation is allowed accordingly.

### BACKGROUND

In some data management systems, data are organized as nodes in a netlike structure. In the netlike system, a node is linked to one or more other nodes in a data structure and the linkage coupling two nodes represents a dependency relationship between them. Different types of dependency relationships may be designated and each may impose certain restrictions on the data management systems. Accordingly, before a data management system activates, updates or deletes a target node, it must identify the nodes that are related to the target node and determine, from the dependency relationships that exist between the target node and its related nodes, whether the intended operation is permissible.

Consider some examples of nodes and dependency relationships that may exist among these nodes in a netlike system, wherein each node in the system represents a scoping element in a business data management system. The scoping element handles the definitions of variables, correlation sets, fault handlers, a compensation handler, event handlers and activities.

Tables A1, A3 and A3 illustrate a parent-child dependency relationship.

TABLE A1

| | Depended element | |
|---|---|---|
| Depending element | (Parent element) | Dependency type |
| Business Package | Business Area | Parent-child |

TABLE A2

| | Depended element | |
|---|---|---|
| Depending element | (Parent element) | Dependency Type |
| Business Topic | Business Package | Parent-child |

TABLE A3

| | Depended element | |
|---|---|---|
| Depending element | (Parent element) | Dependency Type |
| Business Option | Business Topic | Parent-child |

The dependency types in the examples of tables A1-A3 identify a parent child relationship among scoping elements. A parent-child dependency relationship requires that every field of a child element must be a subset of the corresponding field of a parent element. In Table A1, the scoping element Business Area is a parent element of the scoping element Business Package, and each field of the scoping element Business Package must be a subset of the corresponding field of the scoping element Business Area. For example, when the Business Area is medicine manufacturing, the Business Package will be a solution specific to this Business Area. In Table 2, the scoping element Business Topic is a child element of the scoping element Business Package, and accordingly a grandchild element of the scoping element Business Area in Table 1. In Table 3, the scoping element Business Option is a child element of the scoping element Business Topic, and accordingly a grandchild element of the scoping element Business Package in Table 2, and a great-grandchild element of the scoping element Business Area in Table 1. Thus, whenever deleting, activating or updating any element in the chain of scoping elements including Business Area, Business Package, Business Topic, and Business Option, the data management system must check each scoping element in the chain to ensure that each field of a child element is still a subset of the corresponding field of a parent element. In the available approach, three tables must be checked separately.

Tables A4, A5, A6, A7, and A8 illustrate other dependency relationships that may be recognized in a netlike system:

TABLE A4

| Depending element | Depended element | Dependency Type |
|---|---|---|
| Rule Consequence | Rule Condition | Rule |

TABLE A5

| | Depended element | |
|---|---|---|
| Depending element | (Select from element) | Dependency Type |
| Sale Service | Opportunity Management | Pre-selection |

TABLE A6

| | Depended element | |
|---|---|---|
| Depending element | (Replaced element) | Dependency Type |
| Business Option 2 | Business Option 1 | Replacing |

TABLE A7

| | Depended element | |
|---|---|---|
| Depending element | (Mapped to element) | Dependency Type |
| Scenario | Specific Key Question | Mapping |

TABLE A8

| | Depended element | |
|---|---|---|
| Depending element | (Predecessor element) | Dependency Type |
| Business Option | Business Option | Predecessor |

In Table A4, the depending element is the consequence of the depended element Rule Condition. The dependency type designates a causal relationship between the two elements. When such dependency relationships are identified, whenever an operation for deleting, updating and activating one element is called, the other element must be checked to make sure that the rule dependency relationship among the elements are still satisfied. In addition, deleting an the depended element (here, the scoping element Rule Condition) is forbidden.

In Table A5, the scoping element Sale Service is designated as a pre-selection element of the scoping element Opportunity Management. The scoping element Opportunity Management may be used by an enterprise management system (EMS) to evaluate the chance of successful sale and manage the sales methodology. In Table 5, fields of the scoping element Sales Service are pre-selected from the corresponding fields of the scoping element Opportunity Management. When activating or updating one element, the other element must be checked to make sure that the pre-selection relationship among corresponding fields of the elements are satisfied.

In Table A6, a scoping element for Business Option 2 is a replacing element of a scoping element for Business Option 1. Table A7 illustrates a mapping dependency relationship. The depending scoping element Scenario is mapped to the depended scoping element Specific Key Question. In Table A8, the dependency relationship between the two elements is predecessor. In dependency relationships shown in Tables 6, 7 and 8, for two elements in a dependency relationship alone, when an operation for deleting, updating and activating one element is called, it is not necessary to check the other element. However, in a netlike system, one of the two elements of a dependency relationship may be an element in another dependency relationship. For example, the netlike system includes a scoping element Business Option 1, a scoping element Business Option 2 (which is a replacing element for the scoping element Business Option 1), and a scoping element Business Topic (which is a parent element for the scoping element Business Option 1). When a user wants to use the scoping element Business Option 2 to replace the scoping element Business Option 1, the system needs to check whether each field of the scoping element Business Option 2 is a subset of the scoping element Business Topic. Thus, the dependency relationships shown in FIGS. 6, 7, and 8 make the management of the netlike system more complicated.

When activating a target node, or a scoping element, it is necessary to find out whether there is parent-child dependency relationship, rule dependency relationship or pre-selection relationship among the target scoping element and scoping elements related thereto. If so, the user should be informed that he should activate the related scoping elements too.

When updating a target scoping element, it is necessary to find out whether there is parent-child dependency relationship, rule dependency relationship, or pre-selection dependency relationship. If there is one of such dependency relationship, it needs to find out whether the dependency relationship between the target element and its related node allows such an update. If the dependency relationship does not allow such an update, e.g., a field of a child element is no longer a subset of the corresponding field of a parent element, an error message should be presented to the user to indicate that it is not allowed to update the target scoping element.

When deleting a target scoping element, it is necessary to find out whether there is parent-child dependency relationship, rule dependency relationship or pre-selection dependency relationship among the target element and the elements related thereto. For the parent-child dependency relationship, deleting the parent element is forbidden. Deleting child element is allowed, as long as the linkage information is deleted together and a message about the deletion is shown to the user. For a rule relationship, deleting the rule consequence element is allowed, but deleting the rule condition element is forbidden. For pre-selection relationship, deleting either of the nodes is allowed, as long as the linkage information is deleted also and a message about the deletion is shown to the user.

In known node-based data systems, dependency information is distributed in separate tables. The more the nodes, the more the tables the system needs to check when activating, updating or deleting a node. Given the number of dependency relationships and the different requirements for each dependency relationship when deleting, updating and activating a scoping element, the available approach requires considerable time and efforts.

Thus, it would desirable to provide a more effective method for dependency management among data nodes, or scoping element.

### DETAILED DESCRIPTION

Embodiments of the present invention provide a centralized dependency table to save the dependency information about all nodes in a netlike system. When a user activates, modifies or deletes a node, or a scoping element, the system may search the centralized dependency table for the dependency information about the target element and its related elements. Because the dependency information is centrally saved in one table, the dependency relationship check is simplified and efficiency is improved.

In one example, the netlike system has four nodes (or scoping elements): Sales, Opportunity Management, Customer Service, and Sale Service. In an available method, information about these nodes can be organized into five tables as follows:

TABLE 0
(Information of the node Sales)

| Name | Type | Country | Industry |
|---|---|---|---|
| Sales | Business area | US, Canada | High-tech, |
| | | | Automobile |

TABLE 1

| Name | Type | Country | Industry | Parent Node |
|---|---|---|---|---|
| Opportunity | Business | US | High-tech, | Sales |
| Management | Package | | Automobile | |

TABLE 2

| Name | Type | Country | Industry | Parent Node |
|---|---|---|---|---|
| Customer | Business | US | High-tech | Sales |
| Invoice | Package | | | |

TABLE 3

| Name | Type | Country | Industry | Constraint Node |
|---|---|---|---|---|
| Opportunity | Business | US | High-tech, | Customer |
| Management | Package | | Automobile | Service |

TABLE 4

| | | | | Pre-selection |
|---|---|---|---|---|
| Name | Type | Country | Industry | Node |
| Sales Service | Scenario | US | High-tech | Opportunity |
| | | | | Management |

According to Tables 1, and 2, a node Sales is referred to by nodes Opportunity Management and Customer Invoice, and is their parent node. According to Table 3, the dependency relationship between the node Opportunity Management and the node Customer Service is constraint, which means that whenever the node Opportunity Management is selected, the node Customer Service is automatically selected too. According to Table 4, the node Opportunity Management is further related to a node Sales Service. In this embodiment, attributes of these nodes include country and industry.

When a user wants to activate, update or delete the node Sales, the system must check all dependency nodes by getting information from table 0-table 4. It is time consuming.

Table B shows a centralized dependency table according to an embodiment of the present invention.

TABLE B

| | | | | Check Needed | Check |
|---|---|---|---|---|---|
| | Depending | Depended | Dependency | when | Needed when |
| | Node ID | Node ID | Type | Activating/updating | Deleting |
| 1 | Opportunity | Sales | Parent | X | X |
| | Management | | | | |
| 2 | Customer | Sales | Parent | X | X |
| | Invoice | | | | |
| 3 | Opportunity | Customer | Constraint | X | X |
| | Management | Service | | | |
| 4 | Sale Service | Opportunity | Pre-selection | X | |
| | | Management | | | |

Table B has a column for Depending Node identification (“ID”), a column for Depended Node ID, and a column for Dependency Type. For the first dependency relationship in the table, the depending node Opportunity Management depends upon the depended node Sales, wherein the node Sales is a parent node of the node Opportunity Management. For the second dependency relationship in the table, the depending node Customer Invoice depends upon the depended node Sales, wherein the node Sales is a parent node of the node Customer Invoice. For the third dependency relationship in the table, the depending node Opportunity Management depends upon the depended node Customer Service, and the dependency relationship therebetween is constraint. For the fourth dependency relationship in the table, the depending node Sale Service depends upon the depended node Opportunity Management, and the relationship therebetween is pre-selection.

Instead of distributing the dependency relationships among the nodes in multiple tables, as shown in Tables 0-4, in an embodiment of the present invention, a single table (e.g., Table B) is created and utilized in a system for storing all dependency relationships. For example, this embodiment allows that when activating, updating and deleting a node, the system only needs to check Table B, instead of five different tables.

In addition to the nodes and their relationships, the single database of the present invention (e.g., Table B) also may store information about whether the system needs to check the dependency relationships before activating, updating or deleting a node. For all of the exemplary four dependency relationships, when a user wants to activate or update a node, it is necessary to check related nodes. For the first three dependency relationships, when a user wants to delete a node, it is necessary to check whether deleting the node is allowed.

When a user wants to call data in a node, he activates the node in advance. When activating the node Opportunity Management, the user first selects the node in the netlike system. The system then searches for the centralized dependency table, Table B, for the node Opportunity Management. Here, the first, third and fourth pairs of nodes contain the node Opportunity Management, and are located.

From the centralized dependency table, the system is able to read that the node Sales, the node Customer Service, and the node Sale Service need to be checked if the user activates the node Opportunity Management.

In one embodiment, for example, the Country and Industry fields of the nodes need to be checked. The system may compares field Country of the node Opportunity Management with that of the node Sales. Since the node Sales is a parent node of the node Opportunity Management, the country list of the node Opportunity Management should be a subset of the country list of the node Sales. If the result of the check shows otherwise, an error message should be presented to the user to indicate that there is an error and it is not allowed to activate the Opportunity Management node.

If the user wants change the properties of a node, e.g., the Opportunity Management node, he needs to update one or more fields of the node. The system searches the centralized dependency table to find out the related nodes, the dependency relationship between the to be updated node and its related nodes, and, based on the dependency relationship, whether it is necessary to check the related nodes. If the check is necessary, the system checks, for example, in the embodiment shown in Table B, whether the country list of the depending node is a subset of that of the depended node, and whether the industry list of the depending node is a subset of that of the depended node. If not, an error message will be presented to the user to indicate that there is an error and it is not allowed to update the node Opportunity Management.

In a further embodiment, when a node is not useful any more, the user wants to delete the node from the netlike system. The system searches the centralized dependency table for all node pairs containing the node, e.g., node Sales. The first and second pairs of nodes are located. According to the table, a check is needed when deleting these pairs of nodes.

The system then checks the dependency relationship for these pairs of node. For example, according to Table B above, the node Sales is a parent node for the node Opportunity Management and a parent node for the node Customer Invoice. Because in a parent-child relationship, deleting a parent is forbidden. The system provides an error message to the user to indicate that there is an error and it is not allowed to delete the node Sales. Such an error message might be via an information window, popup window, email message, etc. Since the dependency information is maintained in a centralized manner, the system may be able to quickly check the dependency information and respond immediately to the user whether the user's requested action of delete, activate, and/or update, can be implemented.

Referring to Table B, the exemplary centralized dependency table also indicates that the dependency relationship between the node pair Sale Service and Opportunity Management is “pre-selection.” As described above, in a pre-selection dependency relationship, deleting either of the nodes is allowed. Therefore, it is not necessary to check the node pair Sale Service and Opportunity Management before deleting either of these nodes.

The dependency relationships shown in Table B are used for illustration only. Table B could include less dependency relationships, for example, two dependency relationships among three nodes. Table B could include more dependency relationships. In one embodiment, Table B further includes a rule dependency relationship.

In embodiments of the present invention, the centralized dependency table needs to the updated whenever the user updates, activates or deletes a node. In an embodiment, the user updates the table after he updates, activates or deletes a node. In another embodiment, the system could update the dependency table automatically after the user updates, activates or deletes a node. If a change is made to the table, it will immediately affect other nodes in the table.

In a further embodiment, the system checks Table B when receiving a user's request for activating, deleting or updating a node in the table. The data in Table B is compiled by a user and is updated by the system automatically or by the user manually when a user activates, updates or deletes a node in the netlike system.

In one embodiment, the centralized dependency table is stored in a server. The maintenance of data nodes in the netlike system could be controlled by a computer program in the server.

While the invention has been described in detail above with reference to some embodiments, variations within the scope and spirit of the invention will be apparent to those of ordinary skill in the art. For example, although embodiments are described with reference to a computer, other electrical device could be used.

What is claimed is:

1. A method for managing data nodes in a multi-dimensional database system, comprising:
providing a plurality of data nodes, each of the data nodes having a dependency relationship with at least one other of the data nodes; and
creating a centralized dependency table, which stores at least two dependency relationships among at least three data nodes.

2. The method of claim 1, further comprising searching the centralized dependency table for a target node, a node related to the target node, and a dependency relationship between the target node and its related node before a maintenance operation.

3. The method of claim 2, further comprising determining whether it is necessary to perform a check according to the dependency relationship before a maintenance operation.

4. The method of claim 3, further comprising determining whether the maintenance operation is allowed according to the result of the check.

5. The method of claim 4, wherein the maintenance operation is to activate the target data node.

6. The method of claim 5, wherein the check is performed to find out whether the properties of the target node and its related node satisfy their dependency relationship.

7. The method of claim 6, wherein the dependency relationship is a parent-child relationship.

8. The method of claim 7, wherein the check is performed to find out whether a field of a child node is a subset of the corresponding field of a parent node.

9. The method of claim 6, wherein the dependency relationship is a rule relationship.

10. The method of claim 6, wherein the dependency relationship is a pre-selection relationship.

11. The method of claim 6, wherein the dependency relationship is a constraint relationship.

12. The method of claim 6, further comprising presenting an error message when the properties of the target node and its related node do not satisfy their dependency relationship.

13. The method of claim 4, wherein the maintenance operation is to update at least one field of the target node.

14. The method of claim 13, wherein the check is performed to find out whether the update satisfies the dependency relationship between the target node and its related node.

15. The method of claim 14, wherein the dependency relationship is a parent-child relationship.

16. The method of claim 14, wherein the dependency relationship is a rule relationship.

17. The method of claim 14, wherein the dependency relationship is a pre-selection relationship.

18. The method of claim 14, wherein the dependency relationship is a constraint relationship.

19. The method of claim 14, further comprising presenting an error message when the update does not satisfy the dependency relationship between the target node and its related node.

20. The method of claim 4, wherein the maintenance operation is to delete the target node.

21. The method of claim 20, wherein the check is performed to find out whether the dependency relationship between the target node and its related node allows deleting the target node.

22. The method of claim 21, wherein the dependency relationship is parent-child relationship.

23. The method of claim 22, further comprising presenting an error message when the maintenance operation is to delete a parent node.

24. The method of claim 21, wherein the dependency relationship is a rule relationship.

25. The method of claim 24, further comprising presenting an error message when the maintenance operation is to delete a rule condition node.

26. The method of claim 21, wherein the dependency relationship is a constraint relationship.

27. The method of claim 3, further comprising updating the dependency relationship after the maintenance operation.

28. A computer program containing program code for performing a method for managing data nodes in a multi-dimensional database system, the method comprising:
searching a centralized dependency table for a target node, a node related to the target node, and a dependency relationship between the target node and its related node; and
determining whether it is necessary to perform a check according to the dependency relationship before a maintenance operation,
wherein the multi-dimensional database system comprises a plurality of data nodes, each of the data nodes having a dependency relationship with at least one other of the data nodes, and wherein the centralized dependency table stores at least two relationships among at least three data nodes.

29. A netlike data management system, comprising:
a plurality of data nodes, each of the data nodes having a dependency relationship with at least one other of the data nodes;
a centralized dependency table, storing at least two dependency relationships among at least three data nodes; and
a controller for controlling maintenance of the data nodes.

30. The netlike data management system of claim 29, wherein the controller searches the centralized dependency table for a target node, a node related to the target node, and a dependency relationship between the target node and its related node.

31. The netlike data management system of claim 30, wherein the controller determines whether it is necessary to perform a check according to the dependency relationship before a maintenance operation.

32. The netlike data management system of claim 31, wherein the controller further determines whether the maintenance operation is allowed according to the result of the check.

33. The netlike data management system of claim 32, wherein the controller determines whether the properties of the target node and its related node satisfy their dependency relationship before activating the target node.

34. The netlike data management system of claim 32, wherein the controller determines whether an update satisfies the dependency relationship between the target node and its related node before updating the target node.

35. The netlike data management system of claim 32, wherein controller determines whether the dependency relationship between the target node and its related node allows deleting the target node.

36. The netlike data management system of claim 32, wherein the controller presents an error message when the maintenance operation is not allowed by the dependency relationship.

37. The netlike data management system of claim 32, wherein the controller updates the dependency relationship after the maintenance operation.

38. A management method for a data storage system, comprising:
in response to an action command directed to a target object, retrieving from a universal dependency table action permissions associated with the target object, the universal dependency table storing action permissions for all objects stored by the data storage system,
comparing the action command to the retrieved action permissions, and
if the action command is permissible under the action permissions, executing the action command on the target object.

39. The method of claim 38, further comprising, when the comparison identifies another object as a parent object of the target object, comparing properties of a field of the target object to which the action command is directed and properties of a corresponding field of the parent object to determine whether the action command is permissible under the parent object's properties, and
if the action command is permissible under the parent object's properties, executing the action command on the target object,
otherwise, rejecting the action command.
